(19) United States
(12) Patent Application Publication
(10) Pub. No.: US 2004/0155505 A1
(43) Pub. Date: Aug. 12, 2004

(54) Seating for automotive vehicles

(76) Inventor: Thomas W. Schrimsher SR., South Bend, IN (US)

Correspondence Address: JAMES D. HALL, BOTKIN & HALL, LLP, 105 E. JEFFERSON BLVD., SUITE 400, SOUTH BEND, IN, 46601, US

(21) Appl. No.: 10/772,046

(22) Filed: Feb. 4, 2004

Related U.S. Application Data
(63) Continuation of application No. 10/195,088, filed on Jul. 12, 2002, now abandoned.

(51) Int. Cl. A47C 1/02; B60N 2/34

(52) U.S. Cl. 297/343

(57) ABSTRACT

Folding seating for automotive vehicles includes a seat back and a seat bottom both movable mounted on a main frame which is supported in an active position by a leg engaging the floor of the vehicle. The leg is connected to the main frame by a pivot connection to permit the leg to be moved automatically by a rigid actuating link connected to the leg and to the vehicle from a deployed position engaging the floor of the vehicle to a storage position tucked against the main frame as the main frame is pivoted from the active position to a storage position in which the main frame and the seat back and seat bottom extend along the wall of the vehicle to thereby maximize storage space.

### CROSS REFERENCE TO RELATED APPLICATIONS

This application is a continuation of application Ser. No. 10/195,088 filed on Jul. 12, 2002.

### BACKGROUND OF THE INVENTION

This invention relates to folding seating, for use in automotive vehicles, including passenger vans, recreational vehicles and similar vehicles.

Passenger vehicles, such as vans, recreational vehicles, and similar motor vehicles used primarily for transporting passengers but which have interior volumes which occasionally may be used for transporting cargo typically includes passenger seating which is folded away when cargo is to be hauled. Such seating may be normally deployed in a seating arrangement in which the seat back is inclined with respect to the seat, but the seat back may be movable into a position in which the seat back and seat bottom are flush with one another to form a bed. When cargo is to be hauled, it is desirable that both the seat back and the seat bottom be folded as compactly as possible, and, it is also desirable that deployment of the seat into this storage position be accomplished as quickly and as easily possible. Such seating may be anchored to the vehicle but also commonly requires a leg which engages the vehicle floor and which supports the seat is in the seating position. It is desirable that this leg be folded to an out-of-the-way position when the seat is folded into the storage position, since any intrusion by the leg or any other part of the seat into the cargo volume is not desired. Folding legs have been used, but are not automatically folded away when the seat is moved to the storage position. Accordingly, it is desirable to eliminate the need for the supporting legs to be folded separately when the seat is moved to the storage position.

### SUMMARY OF THE INVENTION

According to the present invention, a vehicle seat is provided which may be moved between an active position to permit passenger use of the seat and an inactive position or storage position in which the seat is folded against a wall of the vehicle, thereby increasing the cargo volume of the vehicle. In the active position, the seat may be used in a seating configuration, in which the seat back is reclined to the seat bottom, or in a vehicle bed configuration, in which the seat back is flush with the seat bottom. According to the invention, an edge of a main frame is pivotally secured to a bracket mounted to a wall or similar fixed portion of the vehicle and the other end of which is supported by a folding leg that supports the main frame in the active position. As the main frame is pivoted relative to the bracket from the active or seating position to the storage position, an actuating link extending between the bracket and the leg and pivotally attached to each of them folds the leg against the main frame. A linkage arrangement mounts an upholstered seat bottom and a upholstered seat back. Upholstery on the seat back and seat bottom are supported by a seat frame and a back frame. The linkage arrangement accommodates the slidable and pivoting of the seat frame and back frame relative to one another, so that while the main frame remains in the active position, the seat frame and back frame may be moved relative to one another and relative to the main frame between a seating orientation, which the seat back is reclined with respect to the seat frame, and the aforementioned flush orientation to provide a vehicle bed. Such a linkage arrangement is in itself known to the prior art.

### BRIEF DESCRIPTION OF THE DRAWINGS

These and other advantages of the present invention will become apparent from the following description, with reference to the accompanying drawings, in which:

FIG. 1 is a view in perspective of a vehicle seat made pursuant to the teaching of the present invention, the floor and side wall of the motor vehicle in which the seat is being used being shown schematically;

FIG. 2 is an end view of the seat illustrated in FIG. 1, the seat back and seat bottom being illustrated in the seating position;

FIG. 3 is a view similar to FIG. 2, but illustrating the seat back and seat bottom folded flush relative to one another to form a bed; and

FIG. 4 is a view similar to FIGS. 2 and 3, illustrating the manner in which the seat is folded from the active position as illustrated in FIGS. 2 and 3 which accommodates vehicle passengers to a folded position in which the seat is folded to a compact position to increase the cargo volume of the vehicle.

### DETAILED DESCRIPTION

Referring now to the drawings, a seat made pursuant to the teachings of the present invention is generally indicated by the numeral 10. The seat is illustrated as being supported on a motor vehicle floor, which is illustrated schematically at 12, and a motor vehicle wall 14, which may be an end wall or a side wall of the vehicle. A pair of brackets which is shown at 16, are mounted on the wall 14 adjacent opposite ends of seat 10. A main supporting member or frame 18 is pivotally mounted on bracket 16 by pivot 20. Legs 22 are pivotally mounted on opposite ends of the main supporting member or frame 18 via bracket pivots 23. Each of the legs 22 is connected to their adjacent bracket 16 by a rigid actuating link 24. Each link 24 is connected to its corresponding leg 22 by a pivot connection 26 extending through one end of the link 24 and to their adjacent bracket 16 by pivot connections 28 through the opposite end of each rigid link 24.

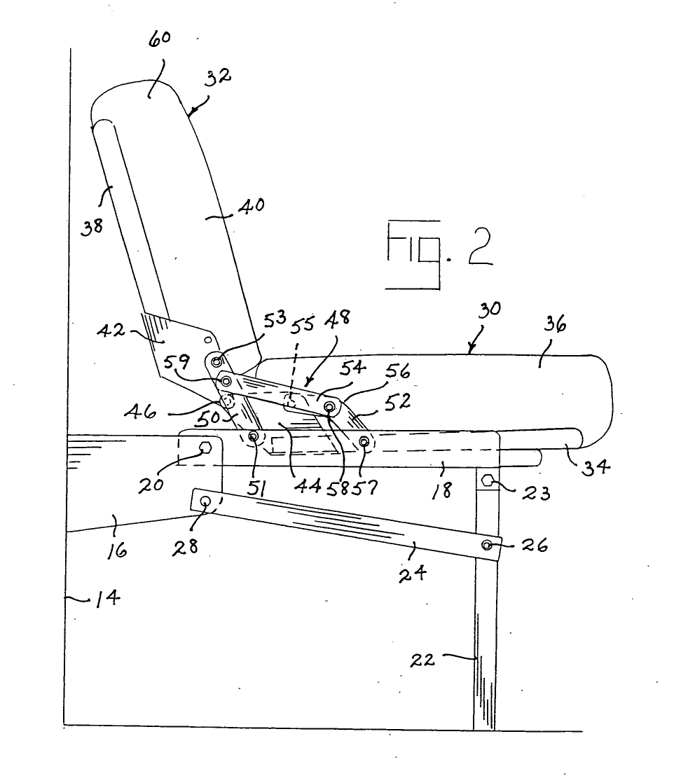

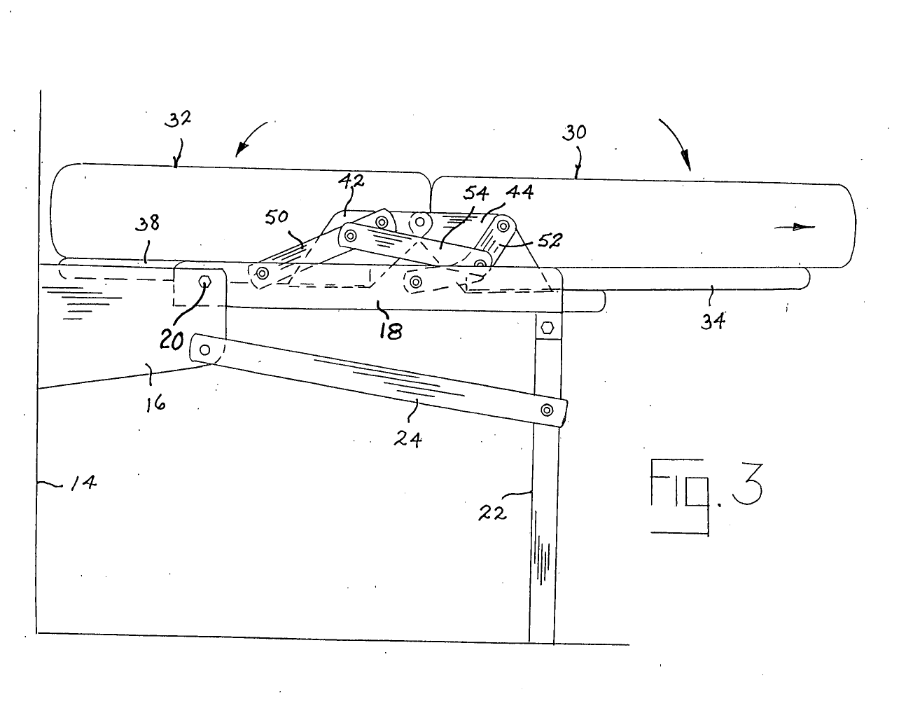

The seat 10 further includes a seat bottom generally indicated by the numeral 30 and a seat back generally indicated by the numeral 32. Seat bottom 30 includes a frame 34 supporting an upholstered pad 36. The frame 34 extends the length of the seat 10. Similarly, seat back 32 includes back frame 38 also extending the length of the seat 10, which supports an upholstered pad 40. Opposite ends of the back frame 38 are provided with brackets, only one of which is shown at 42, which wrap around the lower portion of the edge of the upholstery pad 40 and which are rigidly mounted on the back frame 38. Similarly, seat frame 34 includes a bracket 44 on opposite ends thereof adjacent the rear edge of the seat frame 34 and extending adjacent the seat back 32. The seat bracket 32 is pivotally connected to seat bottom 30 by a pivot connection 46 which pivotally interconnect the brackets 42 with their corresponding brackets 44. An operating linkage generally indicated by the numeral 48 pivotally connects seat back 32 and seat bottom 30 with the main supporting member or frame 18. Linkage 48 includes straight link 50 pivotally connected to supporting member 18 by pivot 51 and to the bracket 42 by pivot 53. An angled link 52 is pivotally connected to the bracket 44 by pivot 55 and to the main supporting member 18 by pivot 57. A straight link 54 is pivotally connected to the link 50 by pivot connection 59 and to the link 52 at the elbow 56 thereof by pivot connection 58. The actuating mechanism 48 including the links 50-54 and the brackets 42 and 44 are known in the prior art to connect a seat bottom 30 to a seat back 32. This linkage and brackets allow the seat 10 to be folded from the seating position illustrated in FIG. 2 to the flush position illustrated in FIG. 3 in which the upholstery pad 40 is substantially flush with the upholstery pad 36.

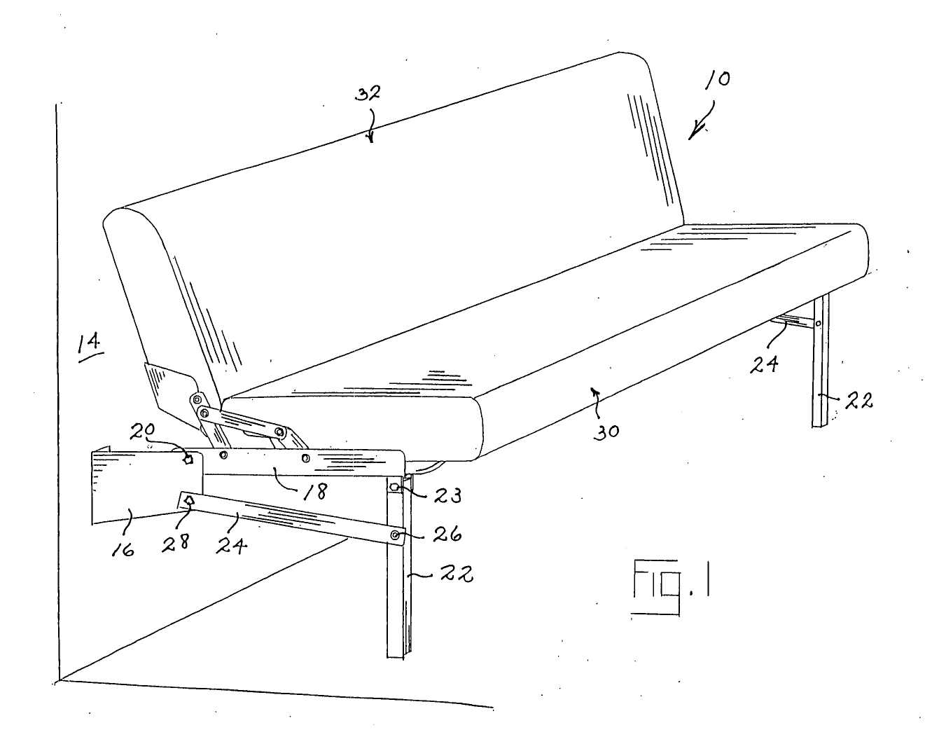

After the seat bottom 30 and seat back 32 have been deployed in the flush position, illustrated in FIG. 3, the entire assembly may be quickly and easily moved to the storage position illustrated in FIG. 4 by merely lifting up on the seat frame 34 to pivot the main supporting member or frame 18 about the pivot 20. As this occurs, the end 60 of the seat back 32 drops between the brackets 16. Simultaneously, the actuating links 24 automatically fold the legs 22 into a substantially vertical position tucked against main frame 18. Accordingly, when deployed in the storage position illustrated in FIG. 4, the seat assembly 10 assumes minimal volume and does not intrude appreciably into the cargo volume found within the vehicles. When the seat assembly is to be redeployed in the active position, the main frame 18 is rotated back to the substantially horizontal or active position illustrated in FIGS. 1-3, thereby permitting the seat back 32 and seat bottom 30 to be redeployed from the flush position into the seating position.

In the claims:

1. Seating for an automotive vehicle comprising a main supporting member pivotally connected to a fixed support mounted to a vertical wall, said main supporting member being movable between a substantially vertical storage position adjacent to said wall and a substantially horizontal use position, a leg pivotally mounted on said main supporting member and movable between an active position projecting from said main supporting member when the main supporting member is in the use position for supporting the main supporting member in said use position and a folded position toward said wall when the main supporting member is in the storage position, a seat frame and a back frame each movably mounted on said main supporting member and movable between a seating position in which the back frame is inclined with respect to the seat frame with said main supporting member in said use position and an auxiliary position permitting the main supporting member to be moved into said storage position, and an actuating link pivotally connected to said support and engaging said leg to move said leg from said active position to said folded position when the main supporting member is moved from said use position to said storage position and from said folded position to said active position as said main supporting member is moved from said storage position to said use position.

2. Seating for automotive vehicles as claimed in claim 1, wherein said seat frame and said back frame are each slidably mounted on said main supporting member and in said auxiliary position are substantially flush with one another to define a substantially flat horizontal sleeping surface when the main supporting member is in the use position.

3. Seating for automotive vehicles as claimed in claim 2, wherein said substantially flat surface defined by said seat frame and said back frame extends substantially vertically when the main supporting member is moved into said storage position.

4. Seating for automotive vehicles as claimed in claim 1, wherein said actuating link is pivotally connected to said leg between the opposite ends thereof.

5. Seating for automotive vehicles as claimed in claim 1, wherein said actuating link is pivotally connected to said leg between the opposite ends thereof and is pivotally connected to said fixed support.

6. Seating for automotive vehicles as claimed in claim 1, wherein said actuating link is a rigid member pivotally connected to said fixed support and pivotally connected to said leg between the opposite ends thereof.

7. Seating for automotive vehicles as claimed in claim 1, wherein said seat frame and said back frame are each pivotally mounted on said main supporting member.

8. Seating for automotive vehicles as claimed in claim 7, wherein said main supporting member supports a linkage means connecting said back frame and said seat frame to said main supporting member for pivotal movement with respect thereto.

9. Seating for automotive vehicles as claimed in claim 7, wherein said seat frame and said back frame are each slidably mounted on said main supporting member and in said auxiliary position are substantially flush with one another to define a substantially flat horizontal sleeping surface when the main supporting member is in said use position.

10. Seating for automotive vehicles as claimed in claim 9, wherein said substantially flat surface defined by said seat frame and said back frame extends substantially vertically when the main supporting member is moved into said storage position.

11. Seating for automotive vehicles as claimed in claim 10, wherein said actuating link is a rigid member pivotally connected to said fixed support and pivotally connected to said leg between the opposite ends thereof.

12. Seating for automotive vehicles comprising a seat frame and a back frame, each of said seat frame and said back frame being movable relative to one another between a seating position in which the seat frame is substantially horizontal and the back frame is inclined with respect to the seat frame and an auxiliary position in which the seat frame and the back frame are movable from an active position to a storage position in which the seat frame and the back frame are substantially vertical along a wall, and a supporting means adapted for pivotal connection at said wall for supporting said seat frame and said back frame for movement between the seating position, the auxiliary position, and the storage position, said supporting means including a leg movable between a supporting position projecting from said frames and supporting said frames in said seating and auxiliary positions and a non-supporting folded position, and an actuating link connected to said leg and adapted for connection at said wall for moving the latter between said supporting position and folded position tucked along said frames as said frames are moved from said active position to said storage position.

13. Seating for automotive vehicles as claimed in claim 12, wherein said actuating link is a rigid member pivotally connected to said support means and pivotally connected to said leg between the opposite ends thereof.

14. Seating for automotive vehicles as claimed in claim 13, wherein said support means includes movable and immovable portions, said immovable portion adapted for connection to said wall, said rigid member being pivotally connected to said immovable portion.

15. Seating for automotive vehicles as claimed in claim 14, wherein said seat frame and said back frame are movably mounted on said movable portion of the support means.

16. Seating for automotive vehicles as claimed in claim 15, wherein said movable portion is connected to said immovable portion through a pivot connection, said movable portion being movable relative to said immovable portion to move said seat frame and said back frame between said active and said storage positions.

17. Seating for automotive vehicles as claimed in claim 16, wherein said seat frame and said back frame are each slidably mounted on said movable portion and in said auxiliary position are substantially flush with one another to define a substantially flat horizontal sleeping surface when the movable portion is in the said active position.
